(19) United States
(12) Patent Application Publication
(10) Pub. No.: US 2025/0340746 A1
(43) Pub. Date: Nov. 6, 2025

(54) INK JET RECORDING METHOD AND INK JET RECORDING APPARATUS

(71) Applicant: CANON KABUSHIKI KAISHA, Tokyo (JP)

(72) Inventors: EIICHI NAKATA, Kanagawa (JP); SAYOKO NAGASHIMA, Kanagawa (JP); NAO ISHIJIMA, Kanagawa (JP)

(21) Appl. No.: 19/196,977

(22) Filed: May 2, 2025

(30) Foreign Application Priority Data
May 2, 2024 (JP) 2024-074803
Apr. 28, 2025 (JP) 2025-074250

(51) Int. Cl. C09D 11/38; B41M 3/00; C09D 11/106; C09D 11/54

(52) U.S. Cl. CPC C09D 11/38; B41M 3/001; C09D 11/106; C09D 11/54

(57) ABSTRACT

An ink jet recording method includes the steps of ejecting an aqueous reaction liquid from an ink jet recording head and applying it to a non-absorbent recording medium, and ejecting and applying an aqueous ink from the recording head so as to overlap at least a part of an area of the recording medium to which the reaction liquid is applied. The aqueous ink contains resin particle, a surfactant A represented by the general formula (1), and a water-soluble organic solvent having a permittivity of 31.5 or less, and a content of the surfactant A in the aqueous ink is 0.01 times or more to 0.08 times or less in a mass ratio with respect to a content of the resin particle.

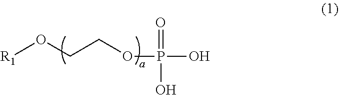

### BACKGROUND OF THE INVENTION

### Field of the Invention

The present invention relates to an ink jet recording method and an ink jet recording apparatus.

### Description of the Related Art

In recent years, the ink jet recording method has been increasingly used in the field of signs and displays, such as recording posters and large-sized advertisements. In this field, from the viewpoint of durability and cost of the recording medium, a polyvinyl chloride sheet, a polyethylene terephthalate (PET) sheet or the like is often used as the recording medium. These are recording media that do not have, or hardly have, an aqueous ink absorbing layer on the recording surface of the recording medium, and are so-called non-absorbent recording media (recording media having no absorbency for aqueous ink) or low-absorbent recording media (recording media having low absorbency for aqueous ink). Conventionally, solvent-based inks, curable inks and the like have been used to record images on these recording media. However, from the viewpoint of reducing environmental load, odor, and the like, the need for aqueous inks using aqueous media is increasing.

In the field of signs and displays, it is required that an excellent high-quality image with good color development and suppressed unevenness can be recorded even on the above-mentioned non-absorbent recording medium or low-absorbent recording medium (hereinafter, these are collectively referred to as “non-absorbent recording medium”). In order to meet such demands, for example, a method of recording an image on a non-absorbent recording medium using a set of an aqueous ink containing resin particle and a nonionic surfactant and a reaction liquid having an action of aggregating components in the ink has been proposed (Japanese Patent Application Laid-Open No. 2018-165314).

### SUMMARY OF THE INVENTION

The present invention is directed to providing an ink jet recording method capable of recording an image having suppressed granularity and excellent color development on a low- to non-absorbent recording medium. Another object of the present invention is to provide an ink jet recording apparatus used in the ink jet recording method.

That is, according to one aspect of the present invention, there is provided an ink jet recording method for recording an image by ejecting an aqueous ink and an aqueous reaction liquid that reacts with the aqueous ink from an ink jet recording head and applying them to a recording medium, the ink jet recording method including the steps of: ejecting the reaction liquid from the recording head and applying it to the recording medium; and ejecting and applying the aqueous ink from the recording head so as to overlap at least a part of an area of the recording medium to which the reaction liquid is applied, wherein the aqueous ink contains resin particle, a surfactant A represented by the following general formula (1) and a water-soluble organic solvent having a permittivity of 31.5 or less, and a content (% by mass) of the surfactant A in the aqueous ink is 0.01 times or more to 0.08 times or less in a mass ratio with respect to a content (% by mass) of the resin particle and the recording medium has a water absorption of 10 mL/m² or less from start of contact to 30 msec^{1/2} in a Bristow method.

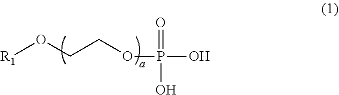

(In the general formula (1), R₁ represents a chain hydrocarbon group having 12 or more to 24 or less carbon atoms, and a represents an integer of 1 or more to 10 or less.)

Further features of the present invention will become apparent from the following description of exemplary embodiments with reference to the attached drawings.

### BRIEF DESCRIPTION OF THE DRAWINGS

FIG. 1 is a perspective view schematically showing an embodiment of an ink jet recording apparatus of the present invention.

FIG. 2 is a side view schematically showing an embodiment of an ink jet recording apparatus of the present invention.

### DESCRIPTION OF THE EMBODIMENTS

Hereinafter, the present invention will be described in more detail with reference to preferred embodiments. In the present invention, when a compound is a salt, the salt is present in a dissociated state as ions in the ink, but for convenience, it is expressed as “containing a salt.” In addition, aqueous ink and reaction liquid for ink jet may be simply referred to as “ink” and “reaction liquid,” respectively. Physical property values are values at room temperature (25° C.) unless otherwise specified. The terms “(meth)acrylic acid” and “(meth)acrylate” mean “acrylic acid and methacrylic acid” and “acrylate and methacrylate,” respectively.

The present inventors examined images recorded on a non-absorbent recording medium using the set proposed in Japanese Patent Application Laid-Open No. 2018-165314. As a result, it was found that the quality (image quality) of the recorded image was not always sufficiently high. Specifically, it was found that it is difficult to achieve both suppression of granularity in a portion where the amount of ink applied is small and improvement of color development in a portion where the amount of ink applied is large.

Therefore, the present inventors diligently studied an ink jet recording method capable of recording an image having suppressed granularity and excellent color development on a low- to non-absorbent recording medium, and as a result, arrived at the present invention.

The present inventors first investigated the reason why it is difficult to achieve both suppression of granularity and improvement of color development in an image recorded on a non-absorbent recording medium. When an image is recorded on a non-absorbent recording medium, it is known that ink and a reaction liquid are brought into contact with each other on the recording medium to appropriately pin (immobilize) ink dots on the recording medium, thereby aggregating the ink dots. Components in the ink that have been rapidly aggregated by contact with the reaction liquid are likely to form aggregate lumps that become uneven on the surface of the recording medium. This makes it easier for light to be scattered on the dot surface, and the color development of the image decreases.

In order to improve the smoothness of the dot surface and improve the color development of the image, for example, it is effective to reduce the amount of the reaction liquid with respect to the amount of ink, or to reduce the components (pigment and resin) in the ink that react with the reaction liquid, but the pinning force of the ink dots also decreases. For this reason, in a portion where the amount of ink applied is small, the dots landed on the recording medium are likely to move, and large dots formed by integrating adjacent dots are visually recognized, making the graininess more noticeable. Therefore, it was found that it is difficult to achieve both suppression of granularity and improvement of color development, which are in a trade-off relationship, only by controlling the aggregability of the components in the ink.

As a result of further studies, the present inventors have found that by using an ink containing a phosphate ester type surfactant (surfactant A) represented by the following general formula (1) and a water-soluble organic solvent having a permittivity of 31.5 or less, an image in which both suppression of granularity and improvement of color development are compatible can be recorded on a non-absorbent recording medium, and have arrived at the present invention. Specifically, the ink used in the ink jet recording method of the present invention contains resin particle and a surfactant A represented by the following general formula (1). The content (% by mass) of the surfactant A in the ink is 0.01 times or more to 0.08 times or less in a mass ratio with respect to the content (% by mass) of the resin particle. Then, the ink is applied so as to overlap at least a part of an area of the recording medium to which the reaction liquid is applied. The present inventors speculate the mechanism by which an image having both suppressed granularity and improved color development can be recorded on a non-absorbent recording medium by the above configuration as follows.

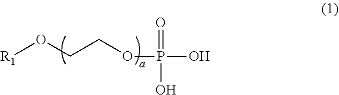

(In the general formula (1), R₁ represents a chain hydrocarbon group having 12 or more to 24 or less carbon atoms, and a represents an integer of 1 or more to 10 or less.)

The surfactant A represented by the general formula (1) has a hydrophobic part represented by R₁, a nonionic part having a repeating structure of ethylene oxide and an anionic part which is a phosphate group. It is considered that the resin particle interacts with the hydrophobic part (R₁) of the surfactant A in the ink. The resin particle that has interacted with the hydrophobic part (R₁) of the surfactant A is moderated in aggregation when it comes into contact with the reaction liquid by the nonionic part (repeating structure of ethylene oxide) of the surfactant A. Here, it is considered that the time from when the ink and the reaction liquid come into contact with each other on the surface of the recording medium until the unevenness of the dot surface is formed is within several hundred milliseconds. Within such a time scale, it is considered that the time until the resin particle comes into contact with the reaction liquid and aggregates increases, and the smoothness of the dot surface improves.

On the other hand, it is recognized that dots move and integrate on the recording medium in units of several tens of μm, and granularity becomes noticeable. The time for dots to move in units of several tens of μm is several seconds. It is important to increase the aggregation viscosity of the dots and increase the pinning force by promoting the reaction between the acid groups of the pigment and those of the resin particle in the ink and the reaction liquid (reactant) during these several seconds. Within such a time scale, the resin particle that has interacted with the hydrophobic part (R₁) of the surfactant A further reacts with the anionic part (phosphate group) of the surfactant A, and the final aggregation viscosity of the dots increases. Thereby, it is considered that the pinning force of the dots is sufficiently enhanced, and granularity is suppressed.

In the present invention, the content (% by mass) of the surfactant A in the aqueous ink is 0.01 times or more to 0.08 times or less in a mass ratio with respect to the content (% by mass) of the resin particle. When the content of the surfactant is 0.01 times or more in terms of the mass ratio with respect to the content (% by mass) of the resin particle, the surfactant A tends to cause aggregation relaxation of the resin particle several hundred milliseconds after the ink and the reaction liquid come into contact with each other, and the color development can be improved. On the other hand, when the content of the surfactant is 0.08 times or less in terms of the mass ratio with respect to the content (% by mass) of the resin particle, the resin particle aggregates several seconds after the ink and the reaction liquid come into contact with each other, and the viscosity can be sufficiently increased, so that the effect of suppressing granularity can be obtained.

Furthermore, the ink used in the ink jet recording method of the present invention contains a water-soluble organic solvent having a permittivity of 31.5 or less. Water-soluble organic solvents having a permittivity of 31.5 or less have a high affinity with the hydrophobic part (R₁) of the surfactant A and the hydrophobic part of the resin particle, as compared with water. Therefore, the ink containing a water-soluble organic solvent having a permittivity of 31.5 or less can interact still more strongly with functional groups present near the surface of the resin particle. It is considered that this effect will make it possible for the surfactant A to come close to the surface of the resin particle.

### <Ink Jet Recording Method and Ink Jet Recording Apparatus>

The ink jet recording method of the present invention is a method of recording an image by ejecting an aqueous ink and an aqueous reaction liquid that reacts with the aqueous ink from an ink jet recording head and applying them to a recording medium. The ink jet recording method of the present invention includes the steps of ejecting the reaction liquid from the recording head and applying it to the recording medium and ejecting and applying the aqueous ink from the recording head so as to overlap at least a part of an area of the recording medium to which the reaction liquid is applied. The aqueous ink contains resin particle, a surfactant A represented by the following general formula (1) and a water-soluble organic solvent having a permittivity of 31.5 or less, and the content (% by mass) of the surfactant A in the aqueous ink is 0.01 times or more to 0.08 times or less in a mass ratio with respect to the content (% by mass) of the resin particle. The recording medium has a water absorption of 10 mL/m² or less from start of contact to 30 msec^{1/2} in a Bristow method.

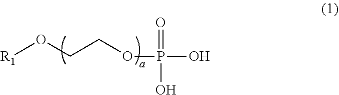

(In the general formula (1), R₁ represents a chain hydrocarbon group having 12 or more to 24 or less carbon atoms, and a represents an integer of 1 or more to 10 or less.)

The ink jet recording apparatus of the present invention is an apparatus used in an ink jet recording method of ejecting an aqueous ink and an aqueous reaction liquid that reacts with the aqueous ink from an ink jet recording head and applying them to a recording medium to record an image. The ink jet recording apparatus of the present invention is an apparatus suitably used for the above recording method. It is not necessary to provide a step of applying a coating liquid or the like containing no coloring material in addition to the ink, or a step of irradiation with active energy rays to cure the image. Hereinafter, the ink jet recording method and the ink jet recording apparatus (hereinafter, also simply referred to as “recording method and recording apparatus”) of the present invention will be described in detail.

### (Ink Jet Recording Apparatus)

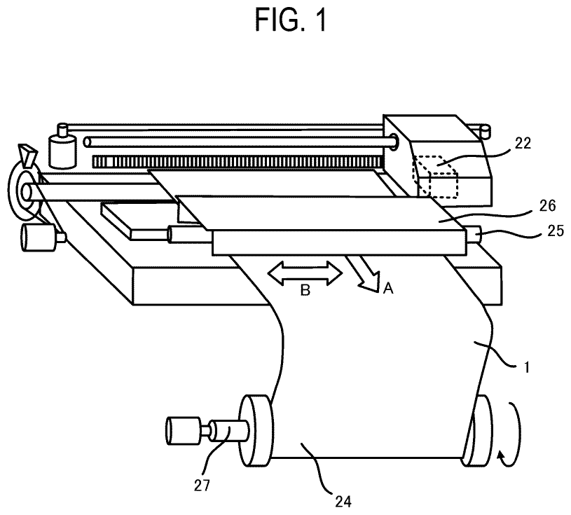

FIG. 1 is a perspective view schematically showing an embodiment of an ink jet recording apparatus of the present invention.

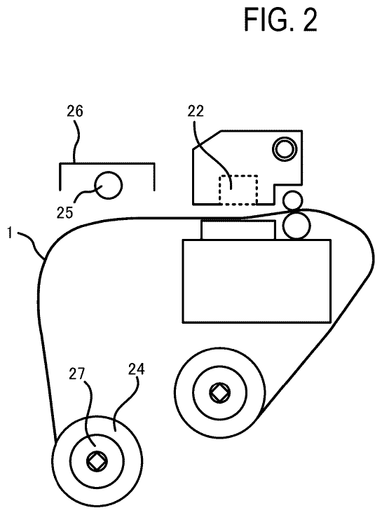

FIG. 2 is a side view schematically showing an embodiment of an ink jet recording apparatus of the present invention. The recording apparatus of the embodiment shown in FIGS. 1 and 2 includes an ink jet recording head 22 that ejects ink and a reaction liquid. Examples of the recording head include a recording head that ejects ink and a reaction liquid by the action of mechanical energy, and a recording head that ejects ink and a reaction liquid by the action of thermal energy. Among them, a recording head that ejects ink and a reaction liquid by the action of thermal energy is preferable. The recording head that ejects ink and a reaction liquid by the action of thermal energy is a thermal type recording head that applies an electric pulse to an electrothermal conversion element to apply thermal energy to the ink and the reaction liquid, and ejects the ink and the reaction liquid from an ejection port. This thermal recording head preferably includes a mechanism (temperature control mechanism) for heating the aqueous ink ejected from the recording head and applied to the recording medium to a predetermined temperature.

### [Heating Step]

The recording method of the present invention preferably further includes a step of heating (heat treatment) the recording medium to which the ink has been applied. By heating the recording medium to which the ink and the reaction liquid have been applied, film formation of the resin particle is promoted, and an image having excellent abrasion resistance can be recorded.

The means for heating the recording medium is not particularly limited, and examples thereof include heating means such as known heating means such as a heater, gas blowing means using a gas blowing such as a dryer, and means combining these. That is, the ink jet recording apparatus preferably includes a mechanism (heating means) for heating the recording medium to which the ink and the reaction liquid have been applied. Examples of the heating means include the above-mentioned heating means, gas blowing means and means combining these. Examples of the heat treatment method include a method of applying heat from the side opposite to the recording surface (ink application surface) of the recording medium (back surface) with a heater or the like, a method of applying warm gas or hot gas to the recording surface of the recording medium and a method of heating from the recording surface or the back surface using an infrared heater.

In the recording apparatus shown in FIGS. 1 and 2, a heater 25 supported by a frame (not shown) is arranged at a position downstream in the sub-scanning direction A from the position where the recording head 22 reciprocates in the main scanning direction B. The recording medium 1 to which the ink has been applied can be heated by the heater 25. Specific examples of the heater 25 include a sheathed heater and a halogen heater. The heater 25 is covered with a heater cover 26. The heater cover 26 is a member for efficiently irradiating the recording medium 1 with the heat generated from the heater 25. Furthermore, the heater cover 26 is also a member that protects the heater 25. The recording medium 1 to which the ink ejected from the recording head 22 has been applied is wound up by a winding spool 27 to form a roll-shaped winding medium 24.

### (Recording Medium)

In the recording method and recording apparatus of the present invention, a non-absorbent recording medium (low- to non-absorbent recording medium) is used as the recording medium. The non-absorbent recording medium is a medium in which, according to the Bristow method described in JAPAN TAPPI Paper Pulp Test Method No. 51 “PAPER AND BOARD-LIQUID ABSORBABILITY TEST METHOD-BRISTOW'S METHOD,” the water absorption amount from the start of contact to 30 msec^{1/2} in the Bristow method is 0 mL/m² or more to 10 mL/m² or less. In the present invention, a recording medium that satisfies the above conditions for the amount of water absorption is defined as a “low- to non-absorbent recording medium.” A recording medium for ink jet recording (glossy paper, matte paper, etc.) having an ink receiving layer formed of inorganic particles, and plain paper having no coat layer are “absorbent recording media” having a water absorption amount of more than 10 mL/m².

Examples of the non-absorbent recording medium include a plastic film; a recording medium in which a plastic film is adhered to a recording surface of a base material; and a recording medium in which an organic resin coat layer is provided on a recording surface of a base material containing cellulose pulp. Among these, a plastic film is preferable, and a recording medium in which an organic resin coat layer as an organic resin layer is provided on the recording surface of a base material containing cellulose pulp is also preferable.

When the ink used in the recording method and recording apparatus of the present invention is applied to a non-absorbent recording medium, components such as water and a water-soluble organic solvent are volatilized and the resin particle is concentrated. Thereby, the fusion between the concentrated resin particle is promoted, and the abrasion resistance of the recorded image is improved. On the other hand, when ink is applied to a recording medium having high absorbency of liquid components, the fusion between the resin particle is not easily promoted, so that the effect of improving the abrasion resistance of the image becomes insufficient. The recording medium in the present specification means a recording medium on which an image as a recorded matter is recorded, not a transfer body.

### (Ink)

The ink is an aqueous ink for ink jet containing resin particle and a surfactant A represented by the general formula (1). Hereinafter, each component constituting the ink will be described in detail.

### [Resin Particle]

The ink contains resin particle. The charge amount (μmol/m²) of the resin particle is preferably 1.0 μmol/m² or more to 2.4 μmol/m² or less from the viewpoint of suppressing granularity and improving color development. If the charge amount of the resin particle is more than 2.4 μmol/m², the resin particle may be strongly aggregated by the reaction liquid, making it difficult to sufficiently fill the unevenness on the dot surface, and the effect of improving color development may be reduced. On the other hand, if the charge amount of the resin particle is less than 1.0 μmol/m², the aggregation of the resin particle by the reaction liquid may be weakened, and the effect of suppressing granularity may be reduced.

The charge amount (μmol/m²) of the resin particle can be measured by colloid titration using a potential difference. In Examples described later, the charge amount of the resin particle was measured by colloid titration using a potential difference using an automatic potentiometric titrator (trade name “AT-510,” manufactured by Kyoto Electronics Manufacturing Co., Ltd.) equipped with a streaming potential titration unit (PCD-500). The pH of the dispersion of the resin particle used for the measurement was adjusted to 8 to 9, and methyl glycol chitosan was used as a titration reagent.

The content (% by mass) of the resin particle in the ink is preferably 0.1% by mass or more to 15.0% by mass or less, and more preferably 1.0% by mass or more to 10.0% by mass or less, based on the total mass of the ink. The content (% by mass) of the resin particle in the ink is preferably 1.5 times or more, more preferably 1.7 times or more, in terms of the mass ratio with respect to the content (% by mass) of the pigment. The above mass ratio is preferably 10.0 times or less. The resin particle is present in the ink in a dispersed state, that is, in the form of a resin emulsion.

The “resin particle” in the present specification means a resin that is present in a state of not being dissolved in an aqueous medium in the ink, and more specifically, means a resin that can be present in the aqueous medium in a state of forming particles whose particle diameter can be measured by a dynamic light scattering method. On the other hand, the “water-soluble resin” means a resin that is present in a state of being dissolved in an aqueous medium in the ink. The “resin particle” can also be referred to as “water-dispersible resin (water-insoluble resin).”

Whether or not a certain resin corresponds to “resin particle” can be determined according to the method shown below. First, a liquid containing a resin to be judged is prepared, and the liquid is diluted with pure water so that the content of the resin is about 1.0% to prepare a sample. Then, when the particle diameter of the resin in the sample is measured by a dynamic light scattering method, if particles having a particle diameter are measured, the resin is determined to be “resin particle” (that is, “water-dispersible resin”). On the other hand, if particles having a particle diameter are not measured, the resin is determined not to be “resin particle” (that is, “water-soluble resin”). The measurement conditions at this time can be, for example, as follows.

### [Measurement Conditions]

SetZero: 30 seconds
Number of measurements: 10 times
Measurement time: 120 seconds
Shape: True sphere
Refractive index: 1.5

### Density: 1.0

As the particle size distribution measuring device, a particle size analyzer using a dynamic light scattering method (for example, trade name “UPA-EX150,” manufactured by Nikkiso Co., Ltd.) can be used. Of course, the particle size distribution measuring device to be used and the measurement conditions are not limited to the above. The average particle diameter (cumulative 50% particle diameter based on volume) of pigment and wax particles can be measured under the above apparatus and conditions.

The average particle diameter of the resin particle is the diameter of particles that are integrated from the small particle diameter side to 50% based on the total volume of the measured particles in the particle diameter integration curve.

The acid value of the resin constituting the resin particle is preferably 5 mg KOH/g or more to 100 mg KOH/g or less. The weight average molecular weight of the resin constituting the resin particle is preferably 1,000 or more to 2,000,000 or less. The average particle diameter of the resin particle measured by a dynamic light scattering method is preferably 50 nm or more to 500 nm or less. The resin particle does not need to include a coloring material.

As the constituent unit of the resin constituting the resin particle, the same units as those constituting the water-soluble resin described later can be appropriately selected and used. Specific examples thereof include acrylic resin, urethane resin, polyester resin and various copolymers.

Examples of the copolymer include styrene-acrylic resin, styrene-butadiene resin, polyether-polyurethane resin and polyester-polyurethane resin.

### [Surfactant A]

The ink contains a surfactant A represented by the following general formula (1).

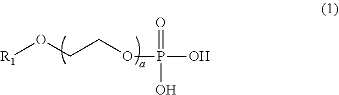

(In the general formula (1), R₁ represents a chain hydrocarbon group having 12 or more to 24 or less carbon atoms, and a represents an integer of 1 or more to 10 or less.)

If the phosphate group in the general formula (1) is a carboxylic acid group or a sulfonic acid group, the color development of the image cannot be improved. Considering the reactivity between the ion-dissociated acid group and the cationic component in the reaction liquid that functions as a reactant, the phosphate group, which has the largest number of anions, takes the longest time to neutralize. It is considered that when a surfactant having a phosphate group is used, the aggregation of the resin particle can be moderated several hundred milliseconds after the ink and the reaction liquid come into contact with each other on the surface of the recording medium.

If the number of carbon atoms of the chain hydrocarbon group represented by R₁ in the general formula (1) is 11 or less or 25 or more, the resin particle does not sufficiently interact with the resin particle, and the effect of suppressing granularity and the effect of improving color development cannot be obtained. If a in the general formula (1) is 0, the aggregation of the resin particle cannot be moderated several hundred milliseconds after the ink and the reaction liquid come into contact with each other, and the color development cannot be improved.

On the other hand, if a in the general formula (1) is 11 or more, even if the resin particle aggregates several seconds after the ink and the reaction liquid come into contact with each other, the repeating structure of ethylene oxide in the general formula (1) is large, so that it becomes difficult to sufficiently increase the aggregation viscosity, and the granularity cannot be suppressed.

The surfactant A is preferably a compound represented by the following general formula (2) because the effect of suppressing granularity and the effect of improving color development can be further enhanced.

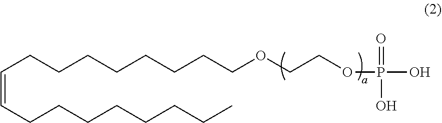

(In the general formula (2), a represents an integer of 1 or more to 10 or less.)

The content (% by mass) of the surfactant A in the ink is 0.01 times or more to 0.08 times or less in a mass ratio with respect to the content (% by mass) of the resin particle. The content (% by mass) of the surfactant A in the ink is more preferably 0.02 times or more to 0.06 times or less. If the above mass ratio is too small, the amount of the surfactant A becomes relatively too small, and the aggregation relaxation of the resin particle several hundred milliseconds after the ink and the reaction liquid come into contact with each other becomes slightly insufficient, and the effect of improving color development may decrease. On the other hand, if the above mass ratio is too large, even if the resin particle aggregates several seconds after the ink and the reaction liquid come into contact with each other, it is difficult to sufficiently increase the viscosity because the amount of the surfactant A is relatively large, and the effect of suppressing granularity may decrease. In the present invention, with respect to the numerical range of the mass ratio of the content (% by mass) of the surfactant A relative to the content (% by mass) of the resin particle in the ink, the absence of a third decimal place in the number means that the third decimal place is zero. For example, the above expression “0.01 times or more to 0.08 times or less” means that “0.010 times or more to 0.080 times or less”.

### [Other Surfactant]

The ink may further contain a surfactant other than the surfactant A (other surfactant). The other surfactant is preferably a silicone-based surfactant from the viewpoint of further improving color development. The silicone-based surfactant can efficiently reduce the contact angle of the ink with respect to the recording medium with a smaller amount than the acetylene glycol-based surfactant. Therefore, by using the silicone-based surfactant, the ink dots can easily spread wet, and the color development can be further improved. If an acetylene glycol-based surfactant is added to sufficiently reduce the contact angle of the ink, the amount added will increase. For this reason, the excess acetylene glycol-based surfactant is likely to interact with the resin particle, and the interaction between the surfactant A and the resin particle is likely to be inhibited, and the effect of suppressing granularity and the effect of improving color development may decrease.

The fluorine-based surfactant tends to be both more oleophobic and hydrophobic than the silicone-based surfactant. For this reason, the fluorine-based surfactant is likely to interact with the resin particle, and the interaction between the surfactant A and the resin particle is likely to be inhibited, and the effect of suppressing granularity and the effect of improving color development may decrease.

### [Coloring Material]

The ink may contain a pigment as a coloring material. The content (% by mass) of the coloring material in the ink is preferably 0.1% by mass or more to 15.0% by mass or less, and more preferably 1.0% by mass or more to 10.0% by mass or less, based on the total mass of the ink.

Specific examples of the pigment include inorganic pigment such as carbon black and titanium oxide; and organic pigment such as azo, phthalocyanine, quinacridone, isoindolinone, imidazolone, diketopyrrolopyrrole, dioxazine and perinone.

As a dispersion method of the pigment, a resin-dispersed pigment using a resin as a dispersant, a self-dispersing pigment in which a hydrophilic group is bonded to the particle surface of the pigment or the like can be used. Further, a resin-bonded pigment in which an organic group containing a resin is chemically bonded to the particle surface of the pigment, a microcapsule pigment in which the surface of pigment particles is coated with a resin or the like or the like can be used. Among them, it is preferable to use a resin-dispersed pigment in which a resin as a dispersant is physically adsorbed on the particle surface of the pigment, instead of a resin-bonded pigment or a microcapsule pigment. That is, the pigment is preferably a pigment dispersed by the action of a resin dispersant.

As the resin dispersant for dispersing the pigment in the aqueous medium, one capable of dispersing the pigment in the aqueous medium by the action of an anionic group is preferably used. As the resin dispersant, a resin described later, particularly a water-soluble resin, can be used. The content (% by mass) of the pigment in the ink is preferably 0.3 times or more to 10.0 times or less in terms of the mass ratio with respect to the content of the resin dispersant.

As the self-dispersing pigment, one in which an anionic group such as a carboxylic acid group, a sulfonic acid group or a phosphonic acid group is bonded to the particle surface of the pigment directly or via another atomic group (—R—) can be used. The anionic group may be either an acid type or a salt type, and in the case of a salt type, it may be in a state where a part of it is dissociated or all of it is dissociated. When the anionic group is a salt type, examples of the counter ion serving as a cation include an alkali metal cation, ammonium and organic ammonium. Specific examples of the other atomic group (—R—) include a linear or branched alkylene group having 1 to 12 carbon atoms; an arylene group such as a phenylene group and a naphthylene group; a carbonyl group; an imino group; an amide group; a sulfonyl group; an ester group; and an ether group. A group obtained by combining these groups may also be used.

### [Resin]

The ink may contain a resin. The content (% by mass) of the resin in the ink is preferably 0.1% by mass or more to 20.0% by mass or less, and more preferably 0.5% by mass or more to 15.0% by mass or less, based on the total mass of the ink.

The resin can be added to the ink (i) to stabilize the dispersed state of the pigment, that is, as a resin dispersant or an auxiliary thereof. Further, (ii) it can be added to the ink to improve various properties of the recorded image. Examples of the form of the resin include a block copolymer, a random copolymer, a graft copolymer and combinations thereof. The resin may be a water-soluble resin that can be dissolved in an aqueous medium, or may be resin particle that is dispersed in an aqueous medium.

### [Composition of Resin]

Examples of the resin include an acrylic resin, a urethane resin and an olefin resin. Among them, an acrylic resin and a urethane resin are preferable, and an acrylic resin composed of a unit derived from (meth)acrylic acid or (meth)acrylate is more preferable.

As the acrylic resin, one having a hydrophilic unit and a hydrophobic unit as constituent units is preferable. Among them, a resin having a hydrophilic unit derived from (meth)acrylic acid and a hydrophobic unit derived from at least one selected from the group consisting of a monomer having an aromatic ring and a (meth)acrylic acid ester monomer is preferable. In particular, a resin having a hydrophilic unit derived from (meth)acrylic acid and a hydrophobic unit derived from at least one monomer selected from the group consisting of styrene and α-methylstyrene is preferable. These resins are suitably used as a resin dispersant for dispersing a pigment because interaction with the pigment is likely to occur.

The hydrophilic unit is a unit having a hydrophilic group such as an anionic group. The hydrophilic unit can be formed, for example, by polymerizing a hydrophilic monomer having a hydrophilic group. Specific examples of the hydrophilic monomer having a hydrophilic group include acidic monomers having a carboxylic acid group such as (meth)acrylic acid, itaconic acid, maleic acid and fumaric acid, and anionic monomers such as anhydrides and salts of these acidic monomers. Examples of the cation constituting the salt of the acidic monomer include ions such as lithium, sodium, potassium, ammonium and organic ammonium. The hydrophobic unit is a unit having no hydrophilic group such as an anionic group. The hydrophobic unit can be formed, for example, by polymerizing a hydrophobic monomer having no hydrophilic group such as an anionic group. Specific examples of the hydrophobic monomer include monomers having an aromatic ring such as styrene, α-methylstyrene and benzyl (meth)acrylate; and (meth)acrylic acid ester monomers such as methyl (meth)acrylate, butyl (meth)acrylate and 2-ethylhexyl (meth)acrylate.

The urethane resin can be obtained, for example, by reacting a polyisocyanate with a polyol. Further, it may be one further reacted with a chain extender. Examples of the olefin resin include polyethylene and polypropylene.

### [Properties of Resin]

The acid value of the water-soluble resin is preferably 100 mg KOH/g or more to 250 mg KOH/g or less. The weight average molecular weight of the water-soluble resin is preferably 3,000 or more to 15,000 or less.

### [Water-Soluble Organic Solvent]

The ink contains a water-soluble organic solvent having a permittivity of 31.5 or less at 25° C. (hereinafter, also referred to as a first water-soluble organic solvent). The permittivity of the water-soluble organic solvent can be measured under the condition of a frequency of 10 kHz using a dielectric constant meter (for example, trade name “BI-870” (manufactured by BROOKHAVEN INSTRUMENTS CORPORATION)). The permittivity of a solid water-soluble organic solvent at a temperature of 25° C. is a value calculated from the following formula (A) by measuring the permittivity of a 50% by mass aqueous solution. Usually, “water-soluble organic solvent” means a liquid, but in the present invention, a substance that is solid at 25° C. (room temperature) is also included in the water-soluble organic solvent.

$${ε}_{sol} = 2 {ε}_{50 \%} - {ε}_{water} \qquad ( A )$$

εₛₒₗ: Permittivity of solid water-soluble organic solvent at 25° C. ε_{50%}: Permittivity of 50% by mass aqueous solution of solid water-soluble organic solvent at 25° C.
ε_{water}: Permittivity of water

Specific examples of water-soluble organic solvents that are solid at 25° C. and are commonly used in aqueous inks include 1,6-hexanediol, trimethylolpropane, ethylene urea, urea and polyethylene glycol having a number average molecular weight of 1,000.

The reason why the permittivity of a water-soluble organic solvent that is solid at 25° C. is calculated from the permittivity of a 50% by mass aqueous solution is as follows. Among water-soluble organic solvents that are solid at 25° C., some of those that can be constituent components of aqueous inks are difficult to prepare a high-concentration aqueous solution exceeding 50% by mass. On the other hand, in a low-concentration aqueous solution of 10% by mass or less, the permittivity of water becomes dominant, and it is difficult to obtain a reliable (effective) value of the permittivity of the water-soluble organic solvent. Therefore, the present inventors conducted a study and found that most of the water-soluble organic solvents that are solid at 25° C. used in inks can be prepared as an aqueous solution to be measured, and the calculated permittivity is also consistent with the effects of the present invention. For the above reasons, in the present invention, the permittivity of a water-soluble organic solvent that is solid at 25° C. is calculated and used from the permittivity of a 50% by mass aqueous solution. For a water-soluble organic solvent that is solid at 25° C. but has low solubility in water and cannot prepare a 50% by mass aqueous solution, the value of permittivity calculated according to the case of calculating the above εₛₒₗ using an aqueous solution of saturated concentration is used for convenience.

Specific examples of the first water-soluble organic solvent having a permittivity of 31.5 or less include 1,4-butanediol (31.1), 1,3-butanediol (30.0), 3-methylsulfolane (29.0), 1,2-propanediol (28.8), 1,2,6-hexanetriol (28.5), 2-methyl-1,3-propanediol (28.3), 2-pyrrolidone (28.0), 1,5-pentanediol (27.0), 1,2-pentanediol (17.4), 3-methyl-1,3-butanediol (24.0), 3-methyl-1,5-pentanediol (23.9), ethanol (23.8), 1-(hydroxymethyl)-5,5-dimethylhydantoin (23.7), triethylene glycol (22.7), tetraethylene glycol (20.8), polyethylene glycol having a number average molecular weight of 200 (18.9), 2-ethyl-1,3-hexanediol (18.5), isopropanol (18.3), 1,2-hexanediol (14.8), n-propanol (12.0), polyethylene glycol having a number average molecular weight of 600 (11.4), triethylene glycol monobutyl ether (9.8), tetraethylene glycol monobutyl ether (9.4), tripropylene glycol monomethyl ether (8.5), 1,6-hexanediol (7.1) and polyethylene glycol having a number average molecular weight of 1,000 (4.6) (the numerical values in parentheses are permittivities at 25° C.). The permittivity of the first water-soluble organic solvent is preferably 3.0 or more.

Among the first water-soluble organic solvents, it is preferable to use one having a permittivity of 29.0 or less.

The content (% by mass) of the first water-soluble organic solvent in the ink is preferably 0.10% by mass or more to 20.00% by mass or less, and more preferably 0.20% by mass or more to 10.00% by mass or less, based on the total mass of the ink. When the content of the first water-soluble organic solvent in the ink is within the above range, the interaction between the surfactant A and the first water-soluble organic solvent can be further promoted. The content (% by mass) of the first water-soluble organic solvent in the ink is preferably 0.10 times or more in terms of the mass ratio with respect to the content (% by mass) of the pigment.

### [Aqueous Medium]

The ink is an aqueous ink containing at least water as an aqueous medium. The ink may contain an aqueous medium which is water or a mixed solvent of water and a water-soluble organic solvent. As the water, deionized water or ion-exchanged water is preferably used. The content (% by mass) of water in the ink is preferably 50.0% by mass or more to 95.0% by mass or less based on the total mass of the ink.

The water-soluble organic solvent contains a water-soluble organic solvent having a permittivity of 31.5 or less. The content (% by mass) of the water-soluble organic solvent in the ink is preferably 3.0% by mass or more to 50.0% by mass or less based on the total mass of the ink. The water-soluble organic solvent is not particularly limited as long as it is water-soluble, and any of those usable in ink jet inks such as alcohols, (poly)alkylene glycols, nitrogen-containing compounds and sulfur-containing compounds can be used. The content (% by mass) of the water-soluble organic solvent (including the first water-soluble organic solvent) in the aqueous ink is preferably 3.00% by mass or more to 50.00% by mass or less based on the total mass of the ink.

Specific examples of the water-soluble organic solvent (including specific examples having a permittivity of 31.5 or less) include monohydric alcohols having 1 to 4 carbon atoms such as methanol (33.1), ethanol (23.8), n-propanol (12.0), isopropanol (18.3), n-butanol, sec-butanol and tert-butanol; dihydric alcohols such as 1,2-propanediol (28.8), 1,3-butanediol (30.0), 1,4-butanediol (31.1), 1,5-pentanediol (27.0), 1,2-pentanediol (17.4), 1,2-hexanediol (14.8), 1,6-hexanediol (7.1), 2-methyl-1,3-propanediol (28.3), 3-methyl-1,3-butanediol (24.0), 3-methyl-1,5-pentanediol (23.9) and 2-ethyl-1,3-hexanediol (18.5); polyhydric alcohols such as 1,2,6-hexanetriol (28.5), glycerin (42.3), trimethylolpropane (33.7) and trimethylolethane; alkylene glycols such as ethylene glycol (40.4), diethylene glycol (31.7), triethylene glycol (22.7), tetraethylene glycol (20.8), butylene glycol, hexylene glycol and thiodiglycol; glycol ethers such as diethylene glycol monomethyl ether, diethylene glycol monoethyl ether, triethylene glycol monoethyl ether and triethylene glycol monobutyl ether (9.8); polyalkylene glycols having a number average molecular weight of 200 to 1,000 such as polyethylene glycol having a number average molecular weight of 200 (18.9), polyethylene glycol having a number average molecular weight of 600 (11.4), polyethylene glycol having a number average molecular weight of 1,000 (4.6) and polypropylene glycol; nitrogen-containing compounds such as 2-pyrrolidone (28.0), N-methyl-2-pyrrolidone (32.0), 1-(2-hydroxyethyl)-2-pyrrolidone (37.6), 1,3-dimethyl-2-imidazolidinone, N-methylmorpholine, urea (110.3), ethylene urea (49.7), triethanolamine (31.9), 1-hydroxymethyl-5,5-dimethylhydantoin (23.7) and 1,3-bis(2-hydroxyethyl)-5,5-dimethylhydantoin (16.0); sulfur-containing compounds such as dimethyl sulfoxide (48.9) and bis(2-hydroxyethyl sulfone); and cyclic ethers such as γ-butyrolactone (41.9) (the numerical values in parentheses are permittivities at 25° C.). The permittivity of the water-soluble organic solvent (excluding the first water-soluble organic solvent) is preferably 3.0 or more. As the water-soluble organic solvent to be contained in the ink, one having a vapor pressure at 25° C. lower than that of water is preferably used.

### [Other Components]

The ink may contain various other components as necessary. Examples of the other components include various additives such as an antifoaming agent, a surfactant, a pH adjuster, a viscosity adjuster, a rust inhibitor, a preservative, an antifungal agent, an antioxidant and a reduction inhibitor. However, the ink preferably does not contain the reactant contained in the reaction liquid.

[Physical Properties of Ink]

The ink is an aqueous ink applied to an ink jet method. Therefore, from the viewpoint of reliability, it is preferable to appropriately control its physical property values. Specifically, the surface tension of the ink at 25° C. is preferably 20 mN/m or more to 60 mN/m or less. The viscosity of the ink at 25° C. is preferably 1.0 mPa·s or more to 10.0 mPa·s or less. The pH of the ink at 25° C. is preferably 7.0 or more to 9.5 or less, and more preferably 8.0 or more to 9.5 or less.

### (Reaction Liquid)

The reaction liquid used in the recording method of the present invention is a liquid containing a reactant that reacts with the ink, and is an aqueous reaction liquid for ink jet used together with the ink. The recording method of the present invention includes, for example, a step of applying a reaction liquid to a recording medium. Among them, it is preferable to apply the reaction liquid before applying the ink to the recording medium, or to apply the ink and the reaction liquid in parallel. Hereinafter, each component used in the reaction liquid will be described in detail.

### [Reactant]

The reaction liquid contains a reactant that reacts with the ink when it comes into contact with the ink, and aggregates components in the ink (resin particle, surfactants and components having an anionic group such as a self-dispersing pigment). Examples of the reactant include an organic acid, a polyvalent metal salt and a cationic resin.

### [Organic Acid]

The reaction liquid containing an organic acid has a buffering capacity in an acidic area (pH less than 7.0, preferably pH 2.0 to 5.0), thereby efficiently converting the anionic groups of the components present in the ink into an acid type and aggregating them. Examples of the organic acid include monocarboxylic acids such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid as well as salts thereof; dicarboxylic acids such as oxalic acid, malonic acid, succinic acid, glutaric acid, adipic acid, maleic acid, fumaric acid, itaconic acid, sebacic acid, phthalic acid, malic acid and tartaric acid as well as salts and hydrogen salts thereof, tricarboxylic acids such as citric acid and trimellitic acid as well as salts and hydrogen salts thereof; and tetracarboxylic acids such as pyromellitic acid as well as salts and hydrogen salts thereof. The content (% by mass) of the organic acid in the reaction liquid is preferably 1.0% by mass or more to 50.0% by mass or less based on the total mass of the reaction liquid.

### [Polyvalent Metal Salt]

The polyvalent metal salt is a compound composed of a divalent or higher valent metal ion (polyvalent metal ion) and an anion. The polyvalent metal salt dissociates in the reaction liquid to become a polyvalent metal ion, and aggregates a pigment or the like dispersed by the action of an anionic group in the ink. Examples of the polyvalent metal ion include divalent metal ions such as Ca²⁺, Cu²⁺, Ni²⁺, Mg²⁺, Sr²⁺, Ba²⁺ and Zn²⁺, and trivalent metal ions such as Fe³⁺, Cr³⁺, Y³⁺ and Al³⁺. Examples of the anion constituting the polyvalent metal salt include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄; and organic anions such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻.

Specific examples of the polyvalent metal salt include calcium carbonate such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, aluminum acetate, aluminum sulfate, calcium methanesulfonate, calcium lactate, magnesium lactate, calcium propionate, calcium pantothenate and calcium gluconate. These polyvalent metal salts may have water of hydration. The content (% by mass) of the polyvalent metal salt in the reaction liquid is preferably 1.0% by mass or more to 20.0% by mass or less based on the total mass of the reaction liquid.

### [Cationic Resin]

The cationic resin has a cationic site in the structure of the resin, and aggregates a pigment or the like dispersed by the action of an anionic group in the ink. Examples of the cationic resin include a resin having a structure of a primary to tertiary amine and a resin having a structure of a quaternary ammonium salt. Specific examples thereof include resins having a structure of vinylamine, allylamine, vinylimidazole, vinylpyridine, dimethylaminoethyl methacrylate, ethyleneimine, guanidine, diallyldimethylammonium chloride and an alkylamine-epichlorohydrin condensate. In order to enhance the solubility in the reaction liquid, an acidic compound and a cationic resin can be used in combination, or a quaternization treatment of the cationic resin can be performed. The content (% by mass) of the cationic resin in the reaction liquid is preferably 0.1% by mass or more to 10.0% by mass or less based on the total mass of the reaction liquid.

The reaction liquid preferably contains at least one reactant selected from the group consisting of a polyvalent metal salt and an organic acid, because the color development of the image can be further improved. The cationic resin has a plurality of cationic units in one molecule. Therefore, when only the cationic resin is used as the reactant, the resin particle is likely to be strongly aggregated, so that it may be difficult to moderate the aggregation of the resin particle several hundred milliseconds after the ink and the reaction liquid come into contact with each other, and the effect of improving color development may be reduced.

The reaction liquid preferably contains a reactant containing: at least one selected from the group consisting of a polyvalent metal salt and an organic acid; and a cationic resin. The polyvalent metal salt and the organic acid have a smaller atomic size or molecular size than the cationic resin, and have a smaller cationic valence per atom or molecule, so that the aggregation reactivity with the resin particle is low. Therefore, when at least one selected from the group consisting of a polyvalent metal salt and an organic acid is used as the reactant without using a cationic resin, even if the resin particle aggregates several seconds after the ink and the reaction liquid come into contact with each other, it may be difficult to sufficiently increase the aggregation viscosity. Thereby, the effect of suppressing granularity may decrease.

The cationic resin is preferably polydiallyldimethylammonium chloride, because the effect of suppressing granularity can be further enhanced. Polydiallyldimethylammonium chloride has a molecular structure in which quaternary ammonium cations are arranged on the side chains, unlike, for example, an alkylamine-epichlorohydrin condensate, and thus is more likely to react with resin particle and pigment. Therefore, polydiallyldimethylammonium chloride is likely to react with the resin particle whose aggregation is suppressed by the surfactant A, and can effectively promote the aggregation reaction to further improve the effect of suppressing granularity.

### [Aqueous Medium]

The reaction liquid is an aqueous reaction liquid containing at least water as an aqueous medium. As the aqueous medium used for the reaction liquid, the same ones as the above-mentioned aqueous medium that can be contained in the ink can be mentioned.

### [Other Components]

The reaction liquid may contain various other components as necessary. Examples of the other components include the same ones as the above-mentioned other components that can be contained in the ink.

### [Physical Properties of Reaction Liquid]

The reaction liquid is an aqueous reaction liquid applied to an ink jet method. Therefore, from the viewpoint of reliability, it is preferable to appropriately control its physical property values. Specifically, the surface tension of the reaction liquid at 25° C. is preferably 20 mN/m or more to 60 mN/m or less. The viscosity of the reaction liquid at 25° C. is preferably 1.0 mPa's or more to 10.0 mPa's or less. The pH of the reaction liquid at 25° C. is preferably 5.0 or more to 9.5 or less, and more preferably 6.0 or more to 9.0 or less.

According to one aspect of the present invention, it is possible to provide an ink jet recording method capable of recording an image having suppressed granularity and excellent color development on a low- to non-absorbent recording medium. According to another aspect of the present invention, it is possible to provide an ink jet recording apparatus used in the ink jet recording method.

### EXAMPLES

Hereinafter, the present invention will be described in more detail with reference to Examples and Comparative Examples, but the present invention is not limited to the following Examples as long as the gist thereof is not exceeded. The terms “parts” and “%” regarding the amount of components are based on mass unless otherwise specified.

### <Preparation of Pigment Dispersion>

### (Pigment Dispersion 1)

A styrene-ethyl acrylate-acrylic acid copolymer (resin dispersant) having an acid value of 150 mg KOH/g and a weight average molecular weight of 8,000 was prepared. 20.0 parts of the resin dispersant was neutralized with potassium hydroxide in an equimolar amount to the acid value, and an appropriate amount of pure water was added to prepare an aqueous solution of the resin dispersant having a resin (solid content) content of 20.0%, 20.0 parts of carbon black (trade name “MCF88,” manufactured by Mitsubishi Chemical Corporation), 30.0 parts of the aqueous solution of the resin dispersant and 50.0 parts of ion-exchanged water were mixed to obtain a mixture. Using a Nano-Mizer (manufactured by Yoshida Kikai Co., Ltd.), the obtained mixture was subjected to 50 passes of dispersion treatment under a pressure of 150 MPa. After removing coarse particles by centrifugation at 5,000 rpm for 30 minutes, the mixture was pressure-filtered with a cellulose acetate filter (manufactured by Advantec Co., Ltd.) having a pore size of 3.0 μm. The mixture was diluted with ion-exchanged water to obtain a pigment dispersion 1 having a pigment content of 10.0% and a resin dispersant content of 3.0%.

### (Pigment Dispersions 2 to 4)

Pigment dispersions 2 to 4 were prepared in the same manner as in the case of the pigment dispersion 1 except that the composition shown in Table 1 was used.

TABLE 1
Composition and properties of pigment dispersion

Pigment Dispersion

| | 1 | 2 | 3 | 4 |
|---|---|---|---|---|
| Carbon Black (Parts) | 20.0 | | | |
| Pigment Blue 15:3 (Parts) | | 20.0 | | |
| Pigment Red 122 (Parts) | | | 20.0 | |
| Pigment Yellow 155 (Parts) | | | | 20.0 |
| Aqueous Solution of Resin | 30.0 | 30.0 | 30.0 | 30.0 |
| Dispersant (Parts) | | | | |
| Ion-exchanged Water (Parts) | 50.0 | 50.0 | 50.0 | 50.0 |
| Pigment Content (%) | 10.0 | 10.0 | 10.0 | 10.0 |
| Resin Dispersant Content (%) | 3.0 | 3.0 | 3.0 | 3.0 |

### <Production of Resin Particle>

### (Resin Particle 1 to Resin Particle 5)

1,160 mL of water was heated to the polymerization temperature shown in Table 2 in a reactor. 160 mL of water and 1.39 g of potassium persulfate were mixed to prepare an initiator solution. 32 mL of the prepared initiator solution was added to the reactor and stirred. 159.4 mL of water, monomers of the types and amounts (g) shown in Table 2, 1.6 g of isooctyl thioglycolate and 9.98 g of a 30% aqueous solution of an emulsifier were mixed to prepare a monomer mixture. As the emulsifier, trade name “Rhodafac RS 710” (manufactured by Rhodia Novecare) was used. The prepared monomer mixture was added dropwise into the reactor over 30 minutes, and at the same time, 129.4 g of the initiator solution was added dropwise into the reactor over 30 minutes and stirred. The reactant was stirred at the polymerization temperature shown in Table 2 and maintained for 3 hours. After cooling to 50° C., a 50% aqueous potassium hydroxide solution was added to adjust the pH to 8.5. After the temperature of the contents was cooled to ambient temperature, the contents were filtered through a 200-mesh filter. Deionized water was added for dilution to obtain aqueous dispersions of resin particles 1 to 5 (resin particle content: 20.0%).

Table 2 shows the properties of the resin particle in the obtained aqueous dispersion.

The meanings of the abbreviations of the monomers in Table 2 are shown below.
MAA: Methacrylic acid
MMA: Methyl methacrylate
HMA: Hexyl methacrylate
nBMA: n-Butyl methacrylate

TABLE 2
Synthesis conditions and properties of resin particle

| | Synthesis Condition | | | | | Properties | | |
|---|---|---|---|---|---|---|---|---|
| | | | | | | Average | | |
| | | | | | Polymerization | Particle | Charge | Charge |
| Resin | Monomer Usage (g) | | | | Temperature | Diameter | Amount | Amount |
| Particle | MAA | MMA | HMA | nBMA | (° C.) | D50 (nm) | (μmol/g) | (μmol/m²) |
| 1 | 0.5 | 49.7 | 23.6 | 26.2 | 65.0 | 160 | 61 | 1.7 |
| 2 | 0.5 | 49.7 | 23.6 | 26.2 | 90.0 | 90 | 61 | 1.0 |
| 3 | 0.4 | 49.8 | 23.6 | 26.2 | 90.0 | 90 | 49 | 0.8 |
| 4 | 0.7 | 49.6 | 23.5 | 26.1 | 65.0 | 160 | 83 | 2.3 |
| 5 | 0.7 | 49.6 | 23.5 | 26.1 | 65.0 | 160 | 85 | 2.4 |

### <Surfactant A>

Twelve types of surfactants A (1 to 12) shown in Table 3 were prepared.

TABLE 3
Types of surfactant A

| | | R₁ | | |
|---|---|---|---|---|
| | | Carbon | | |
| Surfactant | Type | Number | a | Acid Group |
| 1 | Oleth-4 Phosphate | 18 | 4 | Phosphate Group |
| 2 | Oleth-1 Phosphate | 18 | 1 | Phosphate Group |
| 3 | Oleth-Phosphate | 18 | 0 | Phosphate Group |
| 4 | Oleth-10 Phosphate | 18 | 10 | Phosphate Group |
| 5 | Oleth-11 Phosphate | 18 | 11 | Phosphate Group |
| 6 | Lauryl-4 Phosphate | 12 | 4 | Phosphate Group |
| 7 | Undecyl-4 Phosphate | 11 | 4 | Phosphate Group |
| 8 | Lignoceryl-4 Phosphate | 24 | 4 | Phosphate Group |
| 9 | Cetyl-4 Phosphate | 26 | 4 | Phosphate Group |
| 10 | Oleth-4 Sulfonate | 18 | 4 | Sulfonic acid |
| | | | | group |
| 11 | Oleth-4 Carboxylate | 18 | 4 | Carboxylic acid |
| | | | | group |
| 12 | (C12-15) Pareth-6 | 12-15 | 6 | Phosphate Group |
| | Phosphate | | | |

### <Preparation of Ink>

The components (unit: %) shown in Tables 4-1 to 4-3 were mixed and sufficiently stirred, and then pressure-filtered with a membrane filter having a pore size of 4.5 μm (trade name “HDC II Filter,” manufactured by Pall Corporation) to prepare inks 1 to 31, respectively. The details of each component in Tables 4-1 to 4-3 are shown below.
BYK 349: Silicone-based surfactant, manufactured by BYK-Chemie Japan K.K.
Acetylenol E60: Acetylene glycol-based surfactant, manufactured by Kawaken Fine Chemicals Co., Ltd.
FS 3100: Fluorine-based surfactant, manufactured by Capstone
Emulgen 320P: Polyoxyethylene stearyl ether, manufactured by Kao Corporation

TABLE 4-1
Composition and Properties of Ink

| | Ink | | | | | | | | | |
|---|---|---|---|---|---|---|---|---|---|---|
| | 1 | 2 | 3 | 4 | 5 | 6 | 7 | 8 | 9 | 10 |
| Type of pigment dispersion | 1 | 2 | 3 | 4 | 1 | 1 | 1 | 1 | 1 | 1 |
| Type of resin particle | 1 | 1 | 1 | 1 | 2 | 3 | 4 | 5 | 1 | 1 |
| Type of surfactant A | 1 | 1 | 1 | 1 | 1 | 1 | 1 | 1 | 1 | 1 |
| Pigment dispersion | 20.0 | 20.0 | 20.0 | 20.0 | 20.0 | 20.0 | 20.0 | 20.0 | 20.0 | 20.0 |
| Aqueous dispersion of | 25.0 | 25.0 | 25.0 | 25.0 | 25.0 | 25.0 | 25.0 | 25.0 | 25.0 | 25.0 |
| resin particle | | | | | | | | | | |
| Surfactant A | 0.20 | 0.20 | 0.20 | 0.20 | 0.20 | 0.20 | 0.20 | 0.20 | 0.20 | 0.20 |
| 1,2-Butanediol | 15.0 | 15.0 | 15.0 | 15.0 | 15.0 | 15.0 | 15.0 | 15.0 | 15.0 | 15.0 |
| Propylene glycol | 5.0 | 5.0 | 5.0 | 5.0 | 5.0 | 5.0 | 5.0 | 5.0 | 5.0 | 5.0 |
| 1,2-Pentanediol | 0.0 | 0.0 | 0.0 | 0.0 | 0.0 | 0.0 | 0.0 | 0.0 | 0.0 | 0.0 |
| 2-Pyrrolidone | 0.0 | 0.0 | 0.0 | 0.0 | 0.0 | 0.0 | 0.0 | 0.0 | 0.0 | 0.0 |
| Diethylene glycol | 0.0 | 0.0 | 0.0 | 0.0 | 0.0 | 0.0 | 0.0 | 0.0 | 0.0 | 0.0 |
| Glycerin | 0.0 | 0.0 | 0.0 | 0.0 | 0.0 | 0.0 | 0.0 | 0.0 | 0.0 | 0.0 |
| BYK 349 | 1.0 | 1.0 | 1.0 | 1.0 | 1.0 | 1.0 | 1.0 | 1.0 | 0.0 | 0.0 |
| Acetylenol E60 | 0.0 | 0.0 | 0.0 | 0.0 | 0.0 | 0.0 | 0.0 | 0.0 | 4.0 | 0.0 |
| FS 3100 | 0.0 | 0.0 | 0.0 | 0.0 | 0.0 | 0.0 | 0.0 | 0.0 | 0.0 | 1.0 |
| Emulgen 320P | 0.0 | 0.0 | 0.0 | 0.0 | 0.0 | 0.0 | 0.0 | 0.0 | 0.0 | 0.0 |
| Ion-exchanged water | 33.8 | 33.8 | 33.8 | 33.8 | 33.8 | 33.8 | 33.8 | 33.8 | 30.8 | 33.8 |
| Content of surfactant A | 0.2 | 0.2 | 0.2 | 0.2 | 0.2 | 0.2 | 0.2 | 0.2 | 0.2 | 0.2 |
| A(%) | | | | | | | | | | |
| Content of resin particle | 5.0 | 5.0 | 5.0 | 5.0 | 5.0 | 5.0 | 5.0 | 5.0 | 5.0 | 5.0 |
| Em (%) | | | | | | | | | | |
| Value of A/Em (times) | 0.04 | 0.04 | 0.04 | 0.04 | 0.04 | 0.04 | 0.04 | 0.04 | 0.04 | 0.04 |

TABLE 4-2
Composition and Properties of Ink

| | Ink | | | | | | | | | |
|---|---|---|---|---|---|---|---|---|---|---|
| | 11 | 12 | 13 | 14 | 15 | 16 | 17 | 18 | 19 | 20 |
| Type of pigment dispersion | 1 | 1 | 1 | 1 | 1 | 1 | 1 | 1 | 1 | 1 |
| Type of resin particle | 1 | 1 | 1 | 1 | 1 | 1 | 1 | 1 | 1 | 1 |
| Type of surfactant A | 2 | 4 | 6 | 8 | 1 | 1 | 1 | 1 | 7 | 9 |
| Pigment dispersion | 20.0 | 20.0 | 20.0 | 20.0 | 20.0 | 20.0 | 20.0 | 20.0 | 20.0 | 20.0 |
| Aqueous dispersion of | 25.0 | 25.0 | 25.0 | 25.0 | 25.0 | 25.0 | 25.0 | 25.0 | 25.0 | 25.0 |
| resin particle | | | | | | | | | | |
| Surfactant A | 0.20 | 0.20 | 0.20 | 0.20 | 0.10 | 0.05 | 0.30 | 0.40 | 0.20 | 0.20 |
| 1,2-Butanediol | 15.0 | 15.0 | 15.0 | 15.0 | 15.0 | 15.0 | 15.0 | 15.0 | 15.0 | 15.0 |
| Propylene glycol | 5.0 | 5.0 | 5.0 | 5.0 | 5.0 | 5.0 | 5.0 | 5.0 | 5.0 | 5.0 |
| 1,2-Pentanediol | 0.0 | 0.0 | 0.0 | 0.0 | 0.0 | 0.0 | 0.0 | 0.0 | 0.0 | 0.0 |
| 2-Pyrrolidone | 0.0 | 0.0 | 0.0 | 0.0 | 0.0 | 0.0 | 0.0 | 0.0 | 0.0 | 0.0 |
| Diethylene glycol | 0.0 | 0.0 | 0.0 | 0.0 | 0.0 | 0.0 | 0.0 | 0.0 | 0.0 | 0.0 |
| Glycerin | 0.0 | 0.0 | 0.0 | 0.0 | 0.0 | 0.0 | 0.0 | 0.0 | 0.0 | 0.0 |
| BYK 349 | 1.0 | 1.0 | 1.0 | 1.0 | 1.0 | 1.0 | 1.0 | 1.0 | 1.0 | 1.0 |
| Acetylenol E60 | 0.0 | 0.0 | 0.0 | 0.0 | 0.0 | 0.0 | 0.0 | 0.0 | 0.0 | 0.0 |
| FS 3100 | 0.0 | 0.0 | 0.0 | 0.0 | 0.0 | 0.0 | 0.0 | 0.0 | 0.0 | 0.0 |
| Emulgen 320P | 0.0 | 0.0 | 0.0 | 0.0 | 0.0 | 0.0 | 0.0 | 0.0 | 0.0 | 0.0 |
| Ion-exchanged water | 33.8 | 33.8 | 33.8 | 33.8 | 33.9 | 33.95 | 33.7 | 33.55 | 33.8 | 33.8 |
| Content of surfactant A | 0.2 | 0.2 | 0.2 | 0.2 | 0.1 | 0.05 | 0.3 | 0.40 | 0.2 | 0.2 |
| A(%) | | | | | | | | | | |
| Content of resin particle | 5.0 | 5.0 | 5.0 | 5.0 | 5.0 | 5.0 | 5.0 | 5.0 | 5.0 | 5.0 |
| Em (%) | | | | | | | | | | |
| Value of A/Em (times) | 0.04 | 0.04 | 0.04 | 0.04 | 0.02 | 0.01 | 0.06 | 0.08 | 0.04 | 0.04 |

TABLE 4-3
Composition and Properties of Ink

| | Ink | | | | | | | | | | |
|---|---|---|---|---|---|---|---|---|---|---|---|
| | 21 | 22 | 23 | 24 | 25 | 26 | 27 | 28 | 29 | 30 | 31 |
| Type of pigment | 1 | 1 | 1 | 1 | 1 | 1 | 1 | 1 | 1 | 1 | 2 |
| dispersion | | | | | | | | | | | |
| Type of resin particle | 1 | 1 | 1 | 1 | 1 | 1 | 4 | 5 | 5 | 5 | 5 |
| Type of surfactant A | 3 | 5 | 1 | 1 | 10 | 11 | — | — | 6 | 12 | 12 |
| Pigment dispersion | 20.0 | 20.0 | 20.0 | 20.0 | 20.0 | 20.0 | 20.0 | 40.0 | 40.0 | 20.0 | 20.0 |
| Aqueous dispersion of | 30.0 | 30.0 | 30.0 | 30.0 | 30.0 | 30.0 | 14.0 | 30.0 | 30.0 | 50.0 | 50.0 |
| resin particle | | | | | | | | | | | |
| Surfactant A | 0.20 | 0.20 | 0.04 | 0.45 | 0.20 | 0.20 | 0.00 | 0.00 | 0.50 | 0.50 | 0.50 |
| 1,2-Butanediol | 15.0 | 15.0 | 15.0 | 15.0 | 15.0 | 15.0 | 0.0 | 0.0 | 0.0 | 0.0 | 0.0 |
| Propylene glycol | 5.0 | 5.0 | 5.0 | 5.0 | 5.0 | 5.0 | 10.0 | 0.0 | 0.0 | 0.0 | 0.0 |
| 1,2-Pentanediol | 0.0 | 0.0 | 0.0 | 0.0 | 0.0 | 0.0 | 0.0 | 3.0 | 3.0 | 0.0 | 0.0 |
| 2-Pyrrolidone | 0.0 | 0.0 | 0.0 | 0.0 | 0.0 | 0.0 | 0.0 | 8.0 | 8.0 | 0.0 | 0.0 |
| Diethylene glycol | 0.0 | 0.0 | 0.0 | 0.0 | 0.0 | 0.0 | 0.0 | 7.0 | 7.0 | 0.0 | 15.0 |
| Glycerin | 0.0 | 0.0 | 0.0 | 0.0 | 0.0 | 0.0 | 0.0 | 0.0 | 0.0 | 10.0 | 0.0 |
| BYK 349 | 1.0 | 1.0 | 1.0 | 1.0 | 1.0 | 1.0 | 1.0 | 0.0 | 0.0 | 0.0 | 0.0 |
| Acetylenol E60 | 0.0 | 0.0 | 0.0 | 0.0 | 0.0 | 0.0 | 0.0 | 0.0 | 0.0 | 0.0 | 0.0 |
| FS 3100 | 0.0 | 0.0 | 0.0 | 0.0 | 0.0 | 0.0 | 0.0 | 0.0 | 0.0 | 0.0 | 0.0 |
| Emulgen 320P | 0.0 | 0.0 | 0.0 | 0.0 | 0.0 | 0.0 | 0.0 | 0.5 | 0.0 | 0.0 | 0.0 |
| Ion-exchanged water | 33.8 | 33.8 | 33.96 | 33.55 | 33.8 | 33.8 | 44.0 | 11.5 | 11.5 | 19.5 | 14.5 |
| Content of surfactant A | 0.2 | 0.2 | 0.04 | 0.45 | 0.2 | 0.2 | 0.0 | 0.0 | 0.5 | 0.5 | 0.5 |
| A (%) | | | | | | | | | | | |
| Content of resin particle | 5.0 | 5.0 | 5.0 | 5.0 | 5.0 | 5.0 | 5.0 | 6.0 | 6.0 | 10.0 | 10.0 |
| Em (%) | | | | | | | | | | | |
| Value of A/Em (times) | 0.04 | 0.04 | 0.008 | 0.09 | 0.04 | 0.04 | 0.00 | 0.00 | 0.083 | 0.05 | 0.05 |

### <Preparation of Reaction Liquid>

The components (unit: %) shown in Table 5 were mixed and sufficiently stirred, and then pressure-filtered with a membrane filter having a pore size of 4.5 μm (trade name “HDC II Filter,” manufactured by Pall Corporation) to prepare reaction liquids 1 to 7, respectively. The details of each component in Table 5 are shown below.
FLOQUAT FL 2350: Cationic polymer (condensate of dimethylamine and epichlorohydrin) aqueous solution, concentration 50%, manufactured by SNF
POLYQUAT 40 U 05: Cationic resin (polydiallyldimethylammonium chloride) aqueous solution, concentration 50%, manufactured by KATPOL Chemie
Dynol 607: Acetylene glycol-based surfactant, manufactured by Nissin Chemical Industry Co., Ltd.

TABLE 5
Composition of Reaction Liquid

| | | Reaction liquid | | | | | | |
|---|---|---|---|---|---|---|---|---|
| | | 1 | 2 | 3 | 4 | 5 | 6 | 7 |
| Reactant | Magnesium Sulfate | 4.0 | 4.0 | 4.0 | 0.0 | 0.0 | 0.0 | 27.0 |
| | Heptahydrate | | | | | | | |
| | Succinic Acid | 0.0 | 0.0 | 0.0 | 2.0 | 0.0 | 0.0 | 0.0 |
| | FLOQUAT FL2 350 | 0.0 | 1.0 | 0.0 | 0.0 | 0.0 | 0.0 | 0.0 |
| | POLYQUAT 40 U 05 | 1.0 | 0.0 | 0.0 | 0.0 | 4.0 | 0.0 | 0.0 |
| | Calcium Acetate | 0.0 | 0.0 | 0.0 | 0.0 | 0.0 | 1.7 | 0.0 |
| | Monohydrate | | | | | | | |

| | | | | | | | |
|---|---|---|---|---|---|---|---|
| 1,2-Butanediol | 15.0 | 15.0 | 15.0 | 15.0 | 15.0 | 0.0 | 0.0 |
| Propylene Glycol | 15.0 | 15.0 | 15.0 | 15.0 | 15.0 | 0.0 | 0.0 |
| 1,2-Pentanediol | 0.0 | 0.0 | 0.0 | 0.0 | 0.0 | 30.0 | 0.0 |
| 2-Pyrrolidone | 0.0 | 0.0 | 0.0 | 0.0 | 0.0 | 10.0 | 0.0 |
| Glycerin | 0.0 | 0.0 | 0.0 | 0.0 | 0.0 | 0.0 | 10.0 |
| Triethylene Glycol Monobutyl Ether | 0.0 | 0.0 | 0.0 | 0.0 | 0.0 | 0.0 | 10.0 |
| BYK 349 | 1.0 | 1.0 | 1.0 | 1.0 | 1.0 | 0.0 | 0.0 |
| Dynol 607 | 0.0 | 0.0 | 0.0 | 0.0 | 0.0 | 0.5 | 0.0 |
| Ion-exchanged Water | 64.0 | 64.0 | 65.0 | 67.0 | 65.0 | 57.8 | 53.0 |

### <Preparation of Recording Medium>

Recording media 1 and 2 shown below were prepared. The recording medium 1 is a recording medium having a water absorption of 10 mL/m² or less from the start of contact to 30 msec^{1/2} in the Bristow method. On the other hand, the recording medium 2 is a recording medium having a water absorption of more than 10 mL/m² from the start of contact to 30 msec^{1/2} in the Bristow method. Recording medium 1: Trade name “Scotchcal Graphic Film IJ1220,” manufactured by 3M, material: Polyvinyl chloride Recording medium 2: High-quality special paper, trade name “HR-101S,” manufactured by Canon Inc.

### Evaluation (Examples 1 to 22, Comparative Examples 1 to 15)

An ink jet recording apparatus having the configuration shown in FIG. 1 was prepared. This ink jet recording apparatus is defined such that the recording duty of an image recorded under the condition of applying 8 ink droplets of 4.0 ng to a unit area of 1/600 inch×1/600 inch is 100%. The ink and reaction liquid of the combinations shown in Table 7 were filled in the ink applying device and the reaction liquid applying device, respectively. On the recording medium shown in Table 7, 10 types of solid images were recorded with the recording duty of the reaction liquid being 20% and the recording duty being changed in increments of 10% between 10% and 100%, and dried by heating to 80° C. with the heater 25. In the present invention, “A” and “B” were set as acceptable levels, and “C” was set as an unacceptable level in the evaluation criteria for each item shown below. The evaluation results are shown in Table 7. In Table 7, Comparative Examples 12 and 13 correspond to Example 18 and Comparative Example 4 described in Japanese Patent Application Laid-Open No. 2018-165314, respectively.

### (Suppression of Granularity)

Using the above ink jet recording apparatus, the reaction liquid and the ink were applied to the recording medium in this order, and the recorded image with a recording duty of 30% was observed from distances of 20 cm, 30 cm and 50 cm, and the suppression of granularity was evaluated according to the evaluation criteria shown below.

AA: Even when observed from a distance of 20 cm, no roughness due to granularity was observed, and the image was visually recognized uniformly.

A: When observed from a distance of 20 cm, roughness due to granularity was observed, but when observed from a distance of 30 cm, no roughness due to granularity was observed, and the image was visually recognized uniformly.

B: When observed from a distance of 50 cm, no roughness due to granularity was observed and the image was visually recognized uniformly, but when observed from a distance of 30 cm, roughness due to granularity was observed.

C: Even when observed from a distance of 50 cm, roughness due to granularity was observed.

### (Color Development)

Using the above ink jet recording apparatus, for 10 types of solid images recorded by applying the reaction liquid and the ink to the recording medium in this order and changing the recording duty in increments of 10% between 10% and 100%, the lightness (L*) and chroma (C*) of each recorded solid image were measured using a fluorescence spectrophotometer (trade name “FD-7,” manufactured by Konica Minolta, Inc.), and the color development of the image was evaluated according to the evaluation criteria shown in Table 6. L* and C* are based on the color difference display method specified by CIE. In this Example, when the coloring material was carbon black, it was black ink, and when the coloring material was C.I. Pigment Blue 15:3, it was cyan ink. When the coloring material was C.I. Pigment Red 122, it was magenta ink, and when the coloring material was C.I. Pigment Yellow 74, it was yellow ink. In the case of black ink, the smaller the lightness value, the darker the image and the better the color development. In the case of color inks (cyan, magenta and yellow inks), the larger the chroma value, the more vivid the image and the better the color development.

TABLE 6
Evaluation criteria for color development depending on ink type

| Ink type | Evaluation criteria | Evaluation |
|---|---|---|
| Black ink | The minimum value of lightness L* was 9 | A |
| | or less. | |
| | The minimum value of lightness L* was | B |
| | more than 9 to 10 or less. | |
| | The minimum value of lightness L* was | C |
| | more than 10. | |
| Cyan ink | The maximum value of chroma C* was 65 | A |
| | or more. | |
| | The maximum value of chroma C* was 60 | B |
| | or more to less than 65. | |
| | The maximum value of chroma C* was less | C |
| | than 60. | |
| Magenta | The maximum value of chroma C* was 75 | A |
| ink | or more. | |
| | The maximum value of chroma C* was 70 | B |
| | or more to less than 75. | |
| | The maximum value of chroma C* was less | C |
| | than 70. | |
| Yellow | The maximum value of chroma C* was 105 | A |
| ink | or more. | |
| | The maximum value of chroma C* was 100 | B |
| | or more to less than 105. | |
| | The maximum value of chroma C* was less | C |
| | than 100. | |

TABLE 7
Evaluation Conditions and Evaluation Results

| | | | | | Evaluation Results | |
|---|---|---|---|---|---|---|
| | | Evaluation Conditions | | | Suppression | Color |
| | | | Reaction | Recording | of | Devel- |
| | | Ink | Liquid | Medium | Granularity | opment |
| Example | 1 | 1 | 1 | 1 | AA | A |
| | 2 | 2 | 1 | 1 | AA | A |
| | 3 | 3 | 1 | 1 | AA | A |
| | 4 | 4 | 1 | 1 | AA | A |
| | 5 | 5 | 1 | 1 | AA | A |
| | 6 | 6 | 1 | 1 | A | A |
| | 7 | 7 | 1 | 1 | AA | A |
| | 8 | 8 | 1 | 1 | AA | B |
| | 9 | 1 | 2 | 1 | A | A |
| | 10 | 1 | 3 | 1 | B | A |
| | 11 | 1 | 4 | 1 | B | A |
| | 12 | 1 | 5 | 1 | AA | B |
| | 13 | 9 | 1 | 1 | A | B |
| | 14 | 10 | 1 | 1 | A | B |
| | 15 | 11 | 1 | 1 | AA | A |
| | 16 | 12 | 1 | 1 | AA | A |
| | 17 | 13 | 1 | 1 | A | B |
| | 18 | 14 | 1 | 1 | A | B |
| | 19 | 15 | 1 | 1 | AA | A |
| | 20 | 16 | 1 | 1 | AA | B |
| | 21 | 17 | 1 | 1 | AA | A |
| | 22 | 18 | 1 | 1 | A | A |
| Comparative | 1 | 19 | 1 | 1 | C | C |
| Example | 2 | 20 | 1 | 1 | C | C |
| | 3 | 21 | 1 | 1 | AA | C |
| | 4 | 22 | 1 | 1 | C | A |
| | 5 | 23 | 1 | 1 | AA | C |
| | 6 | 24 | 1 | 1 | C | A |
| | 7 | 25 | 1 | 1 | AA | C |
| | 8 | 26 | 1 | 1 | AA | C |
| | 9 | 27 | 1 | 1 | C | C |
| | 10 | 1 | — | 1 | C | A |
| | 11 | 1 | 1 | 2 | AA | C |
| | 12 | 28 | 6 | 1 | C | C |
| | 13 | 29 | 6 | 1 | C | C |
| | 14 | 30 | 7 | 1 | C | C |
| | 15 | 31 | 7 | 1 | C | C |

While the present invention has been described with reference to exemplary embodiments, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2024-074803, filed May 2, 2024, and Japanese Patent Application No. 2025-074250, filed Apr. 28, 2025, which are hereby incorporated by reference herein in their entirety.

What is claimed is:

1. An ink jet recording method for recording an image by ejecting an aqueous ink and an aqueous reaction liquid that reacts with the aqueous ink from an ink jet recording head and applying them to a recording medium, the ink jet recording method comprising the steps of:
ejecting the reaction liquid from the recording head and applying it to the recording medium; and
ejecting and applying the aqueous ink from the recording head so as to overlap at least a part of an area of the recording medium to which the reaction liquid is applied,
wherein the aqueous ink contains resin particle, a surfactant A represented by the following general formula (1) and a water-soluble organic solvent having a permittivity of 31.5 or less,
a content (% by mass) of the surfactant A in the aqueous ink is 0.01 times or more to 0.08 times or less in a mass ratio with respect to a content (% by mass) of the resin particle and
the recording medium has a water absorption of 10 mL/m² or less from start of contact to 30 msec^{1/2} in a Bristow method 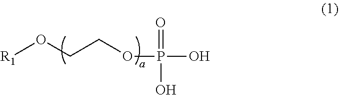
(in the general formula (1), R₁ represents a chain hydrocarbon group having 12 or more to 24 or less carbon atoms, and a represents an integer of 1 or more to 10 or less).

2. The ink jet recording method according to claim 1, wherein the content (% by mass) of the surfactant A in the aqueous ink is 0.02 times or more to 0.06 times or less in a mass ratio with respect to the content (% by mass) of the resin particle.

3. The ink jet recording method according to claim 1, wherein the surfactant A is represented by the following general formula (2) 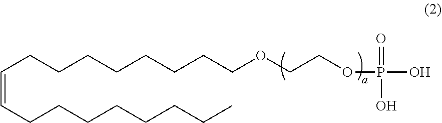
(in the general formula (2), a represents an integer of 1 or more to 10 or less).

4. The ink jet recording method according to claim 1, wherein the aqueous ink further contains a silicone-based surfactant.

5. The ink jet recording method according to claim 1, wherein the reaction liquid contains at least one reactant selected from the group consisting of a polyvalent metal salt and an organic acid.

6. The ink jet recording method according to claim 1, wherein the reaction liquid contains a reactant containing: at least one selected from the group consisting of a polyvalent metal salt and an organic acid; and a cationic resin.

7. The ink jet recording method according to claim 6, wherein the cationic resin is polydiallyldimethylammonium chloride.

8. The ink jet recording method according to claim 1, wherein a charge amount (μmol/m²) of the resin particle is 1.0 μmol/m² or more to 2.4 μmol/m² or less.

9. An ink jet recording apparatus used in an ink jet recording method of ejecting an aqueous ink and an aqueous reaction liquid that reacts with the aqueous ink from an ink jet recording head and applying them to a recording medium to record an image,
wherein the aqueous ink contains resin particle, a surfactant A represented by the following general formula (1) and a water-soluble organic solvent having a permittivity of 31.5 or less,
a content (% by mass) of the surfactant A in the aqueous ink is 0.01 times or more to 0.08 times or less in a mass ratio with respect to a content (% by mass) of the resin particle and
the recording medium has a water absorption of 10 mL/m² or less from start of contact to 30 msec^{1/2} in a Bristow method 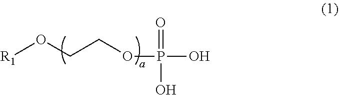
(in the general formula (1), R₁ represents a chain hydrocarbon group having 12 or more to 24 or less carbon atoms, and a represents an integer of 1 or more to 10 or less).
